(19) United States
(12) Patent Application Publication
(10) Pub. No.: US 2009/0142725 A1
(43) Pub. Date: Jun. 4, 2009

(54) DENTAL MATRIX BAND

(76) Inventors: Paul Bryant, Alpine, UT (US); Lee Mecham, Spanish Fork, UT (US)

Correspondence Address: DAVID R. MCKINNEY, P.C., P.O. BOX 1460, SANDY, UT, 84091, US

(21) Appl. No.: 12/125,311

(22) Filed: May 22, 2008

Related U.S. Application Data
(60) Provisional application No. 61/004,800, filed on Dec. 3, 2007.

(51) Int. Cl. A61C 5/04

(52) U.S. Cl. 433/39

(57) ABSTRACT

A dental matrix band includes a body portion, having a fluoropolymer layer disposed thereon. The fluoropolymer layer reduces undesirable adhesion between dental restorative material and the matrix band. In one embodiment, the fluoropolymer is applied onto the body portion of a stainless steel matrix band in a layer having a thickness in the range of from approximately 0.0005 inches to 0.001 inches.

### PRIORITY CLAIM

The present application claims priority from U.S. Provisional patent application Ser. No. 61/004,800, filed on Dec. 3, 2007, and entitled FLUOROCARBON (FLUOROPOLYMER) DENTAL MATRIX BAND.

### BACKGROUND

1. Field of the Invention

This disclosure relates generally to dental matrix bands. More particularly, the present disclosure relates to a matrix band that has a lesser tendency to adhere to modern restorative materials for filling or repairing teeth.

2. Related Art

Matrix bands are widely used by dentists while filling cavities on any of the vertical surfaces of a tooth. Matrix bands are typically made like the well-known Tofflemire design. Typical matrix bands are formed of thin, foil-like stainless steel metal. A matrix band is typically wrapped around the tooth to be repaired and held in place using a conventional band retainer appliance. With the matrix band in place, the dentist can apply restorative material to the side of the tooth inside the band. The matrix band is removed from about the tooth once the restorative material is set.

In recent years, newer, better restorative materials have been developed for restoring teeth and/or filling cavities. These new materials include bonded amalgam alloys and composite resins that bond to the tooth through micromechanical or chemical retention. There about 25 different kinds of these newer materials. One advantage of these newer materials is that they tend to adhere better, providing a more retentive tooth repair. One undesirable aspect of these new materials, however, is that these restorative materials tend to bond to a conventional matrix band, which is typically made of stainless steel. If the restorative material adheres to the matrix band, the matrix band may be undesirably affixed to the restored tooth. Additionally, removal of the matrix band can result in removing the newly placed filling material. Bonding between the matrix band and the restorative material is generally undesirable.

Some attempts have been made to prevent the bonding between dental restorative materials and matrix bands. For example, some dentists use wax, petroleum jelly, cavity varnish or mineral oil placed upon the matrix band in an attempt to prevent the restorative material from adhering to the matrix band. Unfortunately, such substances can leave a residue on the tooth, thereby preventing an optimum bond between the restorative material and the tooth. These substances can also increase the thickness of the matrix band, thereby making it more difficult to work with. Moreover, in some cases, the added substance can damage the matrix band.

### SUMMARY

It has been recognized that it would be advantageous to develop a matrix band that is useful in tooth restoration applications and does not have a tendency to adhere or bond to modern day restorative materials.

It has also been recognized that it would be advantageous to have a dental matrix band that is thin and flexible, yet strong, and that does not introduce substances that can hinder the bonding of dental restorative material to a tooth.

In accordance with one embodiment thereof, the present invention provides a dental matrix band that includes a body portion having a central tooth circumscribing portion extending between and merging with a pair of arms. The arms are adapted to generally surround a pre-selected tooth that is to be repaired. A layer of fluoropolymer material is disposed upon the body portion, such that the layer extends over the central tooth circumscribing portion.

In a more particular embodiment, the matrix band body portion is made of stainless steel, and the layer of fluoropolymer is plated on the body portion.

In another more particular embodiment, the fluoropolymer layer is made of FDA approved fluoropolymer having a thickness in the range between about 0.0005 and 0.001 inches.

### BRIEF DESCRIPTION OF THE DRAWINGS

Additional features and advantages of the present invention will be apparent from the detailed description which follows, taken in conjunction with the accompanying drawings, which together illustrate, by way of example, features of the invention, and wherein:

FIG. 1 is a perspective view of one embodiment of a matrix band configured in accordance with the present disclosure;

FIG. 2 is a perspective view of another embodiment of a matrix band configured in accordance with the present disclosure; and

FIG. 3 is a partial cross-sectional view of one embodiment of a matrix band configured in accordance with the present disclosure wrapped about a tooth.

### DETAILED DESCRIPTION

Reference will now be made to exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

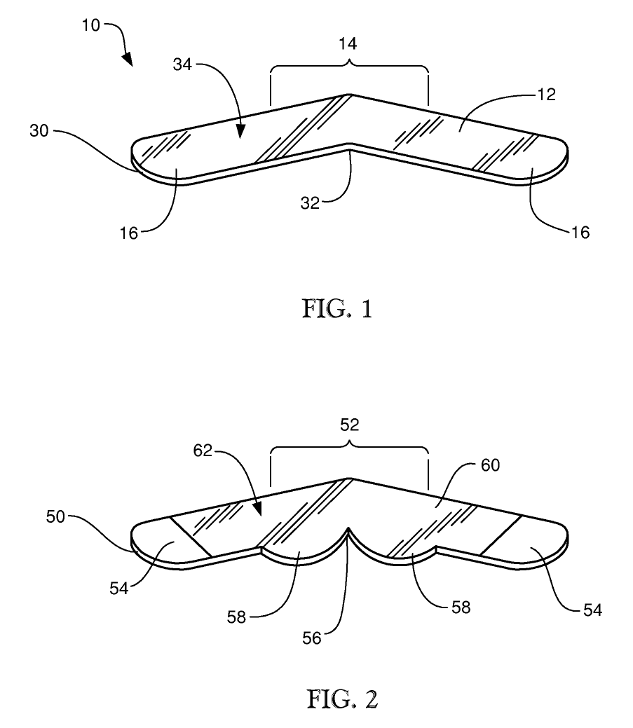

Shown in FIGS. 1 and 2 are two embodiments of matrix bands configured in accordance with the present disclosure. Referring to FIG. 1, one embodiment of a matrix band 10 in accordance with the present disclosure comprises a generally flat body 30 of flexible material, having a central portion 14 and two arms 16 extending in generally opposite directions. This embodiment is configured in accordance with the well-known Tofflemire design, and includes a slight angular bend 32 approximately at its center. The matrix band can be made of a thin piece of foil-like material, such as stainless steel. Grade 316 and 420 stainless steel are commonly used for surgical applications, and can be used for a dental matrix band. Alloys that include tin, nickel and chromium, for example, can also be used. Other materials can also be used. For example, aluminum and plastic matrix bands have been produced. The inventors believe that carbon fiber composite matrix bands have also been attempted. Those of skill in the art will recognize that aluminum and plastic matrix bands are not as strong as steel, and thus aluminum and plastic matrix bands tend to be much thicker in order to have the desired strength. The body of the matrix band can be about 65 mm long and about 10 mm wide, with a thickness in the range of 0.001 to 0.002 inches. The thickness of the matrix band is greatly exaggerated in the figures for illustrative purposes.

Another embodiment of a matrix band is shown in FIG. 2. This embodiment comprises a generally flat body 50 of flexible material, having a central portion 52 and two arms 54 extending in generally opposite directions, with a slight angular bend 56 approximately at its center. This embodiment also includes a pair of downwardly extending lobes 58 that extend in opposing directions from the angular bend location. These lobes are provided to accommodate larger or irregular surface areas. This type of dental matrix band is not as commonly used as that in FIG. 1, but are preferred by some dentists.

Advantageously, a matrix band like those shown in FIGS. 1 and 2 can include a layer of fluoropolymer on their outer surface to help prevent adhesion of the matrix band to dental restorative materials. The term “fluoropolymer” refers generally to any polymer that contains atoms of fluorine. Fluoropolymers are characterized by low friction, and a high resistance to solvents, acids, and bases. Fluoropolymers were discovered serendipitously in 1938 when a researcher working on Freon® accidentally polymerized tetrafluoroethylene. The result was polytetrafluoroethylene (PTFE), which was found to have the lowest coefficient of friction of any known solid at that time, and was found to be inert to virtually all chemicals. Fluoropolymers may be mechanically characterized as thermosets or thermoplastics. They are often applied to manufactured metal parts by baking, electrostatic powder coating, or attached in large sheets with epoxy.

PTFE is currently sold by the DuPont Corporation under the well-known trademark Teflon®. This trademark is also applied by DuPont to products made from two other types of fluoropolymers: Teflon-PFA, which is a perfluoroalkoxy; and Teflon-FEP, which is a fluorinated ethylene propylene. These and other fluoropolymer materials can be used with dental matrix bands in accordance with the present disclosure. Those of skill in the art will recognize that many types of fluoropolymers are commercially available from various commercial sources and are sold under various trade names or trademarks. It is believed that fluoropolymers beyond those specifically listed above can be used with dental matrix bands in accordance with the present disclosure. Additionally, different varieties of fluoropolymers can be used to obtain particular characteristics, such as to increase the strength and/or hardness of the fluoropolymer layer. One particular material that is suitable for coating a matrix band in accordance with this disclosure is a Teflon® material that comes in various grades, some of which have been approved by the U.S. Food and Drug Administration (FDA) for use in dental and medical applications. Nevertheless, for oral, non-invasive dental appliances, FDA approved fluoropolymers are not required, and the coated dental matrix band disclosed herein can be configured with any one of many varieties or grades of fluoropolymer, including those that are approved by a government agency and others that are not.

A fluoropolymer is a desirable material to be disposed on the body portion of the matrix band because it is a poor bond acceptor. Consequently, in using modern restorative materials, such as amalgam bonding agents and composite resins, there is less likelihood that a matrix band coated with fluoropolymer will bond to those materials. A barrier between a conventional stainless steel matrix band and the bonding agent is desirable due to the high bond strength of modem restorative materials. Furthermore, the use of fluoropolymer in accordance with this disclosure is advantageous because of its hypoallergenic qualities. Fluoropolymer is much less likely to cause an allergic reaction than stainless steel, which includes significant quantities of nickel, a common allergen.

The desirable thickness of the fluoropolymer layer depends upon a number of criteria. First, it is desirable that the band remain flexible such that it can be used in a way that is consistent with conventional matrix bands. Second, the thickness of the layer of fluoropolymer should not interfere with insertion of the band between adjacent teeth. The inventors believe that, ideally, the layer of fluoropolymer should not increase the thickness of the matrix band by more than approximately 0.001 inches. Third, the fluoropolymer should not be worn through if burnished with a smooth metal object. Contact with dental instruments during a tooth restoration procedure can wear through the fluoropolymer layer if it is too thin.

It is also desirable that the underlying stainless steel surface of the matrix band not be exposed if the band is bent once, twice or several times. This is desirable because, in manipulating a matrix band in order to place it around a tooth, the band is often flexed and relaxed then flexed again before it is placed about the tooth. It is also desirable that the layer of fluoropolymer be resistant to high temperatures and/or pressurized steam. Typical temperatures to which the matrix band may be exposed during a tooth restoration procedure can be in the range from 300° F. to 450° F. Typical steam pressures can range from approximately 30 psi to 1 atmosphere.

Considering these criteria, the inventors have found that a suitable thickness of the fluoropolymer layer can be in the range of from approximately 0.0005 inches to 0.001 inches. However, other thicknesses can be used. For example, it is believed that fluoropolymer layers that are thicker than 0.001 inches can be used in many circumstances. Aluminum (or other metal) matrix bands can also be coated in the manner discussed herein. A plastic matrix band, on the other hand, can be entirely of fluoropolymer, such as FEP Teflon®.

In one embodiment, the layer of fluoropolymer can be applied directly onto the body portion of matrix band. Various methods of applying the fluoropolymer to the matrix band can be used. In one method, the inventors have sprayed a liquid fluoropolymer onto the matrix band, then cured the liquid coating onto the band by baking the band at about 400° F. for about 15 minutes, then baking at 600° F. for about another 15 minutes. This method is desirable because no nickel or other metal need be introduced between the fluoropolymer and the stainless steel matrix band. Fluoropolymer materials can also be applied to the band in a powdered form, with the recognition that application of a powder tends to provide a thicker fluoropolymer coating. Another method that can be used is electroplating. These methods of applying polymer materials to a metal substrate are well known to those of skill in the art. The fluoropolymer material can be applied to an entire sheet of metal prior to cutting to form individual matrix bands. Alternatively, the fluoropolymer material can be applied to individual bands one by one.

As shown in FIG. 1, the fluoropolymer layer 12 can cover substantially the entire top surface 34 of the matrix band 10. Alternatively, as illustrated in FIG. 2, a layer 60 of fluoropolymer can disposed on top surface 62 of the central tooth circumscribing portion 52 of the band, and can also be applied to a portion, but not the entirety of the linearly extending arms 54. It is to be understood that FIG. 1 can have an extent of coverage of the fluoropolymer layer like that shown in FIG. 2, and vice versa. Other configurations of partial or complete fluoropolymer coverage can also be used.

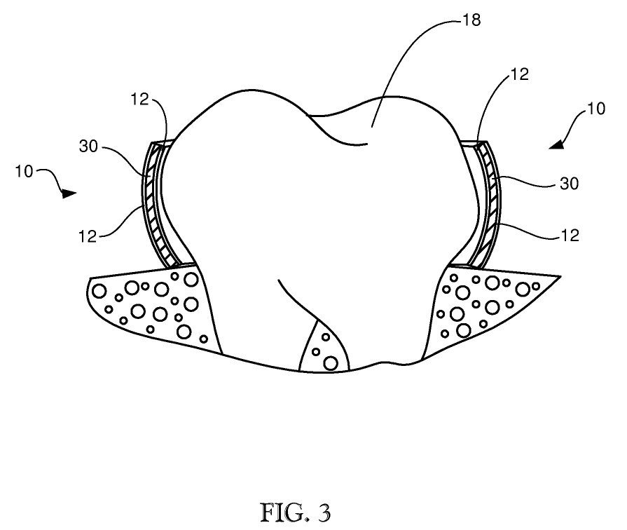

Similarly, the fluoropolymer layer can be applied to one or both sides of the matrix band. Where only one side of a matrix band is provided with a fluoropolymer layer, it is desirable that a dentist be aware of which side of the band includes the fluoropolymer, so that the proper side is placed toward the tooth and, therefore, toward the restorative material. Shown in FIG. 3 is a matrix band 10 like that of FIG. 1 in partial cross-sectional view surrounding a tooth 18. This embodiment includes a layer 12 of fluoropolymer on both sides of the matrix band body 30. It is to be appreciated that the thicknesses of the matrix band and of the fluoropolymer layers are greatly exaggerated in this view for illustrative purposes. Where both sides of the matrix band are provided with a fluoropolymer layer, the user does not need to worry about placing the correct surface in contact with the tooth. One side of the matrix band will faces inward toward the tooth 18, while the other side faces outward, away from the tooth. The cross-hatched region represents the body 30 of the matrix band 10.

There is thus disclosed a dental matrix band with a low friction fluoropolymer coating that reduces the risk of dental restorative material from adhering to the matrix band. The coating does not interfere with the flexibility and other desirable characteristics of the matrix band, and can be applied relatively simply and inexpensively.

It is to be understood that the above-referenced arrangements are illustrative of the application of the principles of the present invention. It will be apparent to those of ordinary skill in the art that numerous modifications can be made without departing from the principles and concepts of the invention as set forth in the claims.

What is claimed is:

1. A dental matrix band, comprising:
a substantially flat body, having a central tooth circumscribing portion extending between and merging with a pair of arms adapted to generally surround a pre-selected tooth; and
a layer of fluoropolymer, disposed on the central tooth circumscribing portion.

2. A matrix band in accordance with claim 1, wherein the body is of stainless steel.

3. A matrix band in accordance with claim 1, wherein the layer of fluoropolymer is coated on the body portion.

4. A matrix band in accordance with claim 3, wherein the layer of fluoropolymer comprises PTFE.

5. A matrix band in accordance with claim 1, wherein the layer of fluoropolymer has a thickness in the range of about 0.0005 inches to about 0.001 inches.

6. A matrix band in accordance with claim 1, wherein the body has a thickness in the range of 0.001 to 0.002 inches thick, and the layer of fluoropolymer is about 0.001 inches thick.

7. A matrix band in accordance with claim 1, wherein the body has a first side that faces the pre-selected tooth when the band is in use for repairing the tooth, and a second side that faces away from the tooth when the band is in use, and wherein the layer of fluoropolymer is disposed on the first side of the body.

8. A matrix band in accordance with claim 7, wherein the layer of fluoropolymer is disposed on the first and second sides of the body.

9. A matrix band in accordance with claim 1, wherein the pair of arms have a length, and the layer of fluoropolymer extends over a portion of the length of each of the arms.

10. A matrix band in accordance with claim 1, wherein the layer of fluoropolymer is electroplated on the body.

11. A matrix band in accordance with claim 10, wherein the layer of fluoropolymer comprises PTFE.

12. A matrix band in accordance with claim 1, wherein the layer of fluoropolymer is disposed upon substantially the entire body.

13. A dental matrix band, comprising:
a substantially flat body, having two sides, and a central tooth circumscribing portion extending between and merging with a pair of arms adapted to generally surround a pre-selected tooth; and
a layer of fluoropolymer, disposed on one side of the body, such that the layer of fluoropolymer extends over the entire the central tooth circumscribing portion.

14. A matrix band in accordance with claim 13, wherein the layer of fluoropolymer is disposed on both sides of the body.

15. A matrix band in accordance with claim 13, wherein the layer of fluoropolymer is disposed upon the entire the body portion.

16. A matrix band in accordance with claim 15, wherein the layer of fluoropolymer is disposed on the two sides of the body portion.

17. A dental matrix band, comprising:
a body portion, made from stainless steel, having a central tooth circumscribing portion extending between and merging with a pair of arms adapted to generally surround a pre-selected tooth; and
a layer of fluoropolymer disposed on the body portion such that the layer of fluoropolymer extends over the central tooth circumscribing portion

18. A matrix band in accordance with claim 17, wherein the layer of fluoropolymer comprises PTFE.

19. A matrix band in accordance with claim 17, wherein the body has a thickness in the range of 0.001 to 0.002 inches thick, and the layer of fluoropolymer has a thickness in the range of about 0.0005 inches to about 0.001 inches.

20. A matrix band in accordance with claim 17, wherein the layer of fluoropolymer is applied to the body by a method selected from the group consisting of spray coating, powder coating, and electroplating.
